(19) United States
(12) Patent Application Publication
(10) Pub. No.: US 2007/0161317 A1
(43) Pub. Date: Jul. 12, 2007

(54) Method for producing discharge lamps

(76) Inventors: Klaus-Dieter Bauer, Landau (DE); Frank Vollkommer, Buchendorf (DE)

Correspondence Address: OSRAM SYLVANIA INC, 100 ENDICOTT STREET, DANVERS, MA, 01923, US

(21) Appl. No.: 10/586,812

(22) PCT Filed: Jan. 14, 2005
(86) PCT No.: PCT/DE05/00044

§ 371 Date: Nov. 24, 2006

(30) Foreign Application Priority Data
Jan. 28, 2004 (DE) 102004004478.3

(51) Int. Cl. H01J 9/00

(52) U.S. Cl. 445/26

(57) ABSTRACT

A process for producing a discharge lamp, includes the following process steps: providing a discharge vessel, producing a paste for a functional layer from the components: pulverulent base material, polyalkylene carbonate as binder and solvent, forming the functional layer by applying the paste to at least part of the wall of the discharge vessel. The type of base material depends on the type of functional layer, such as for example phosphor layer, reflective layer or soldering glass layer. The use of a polyalkylene carbonate as binder allows the binder to be removed without leaving any residues at relatively low binder-removal temperatures and therefore allows efficient lamps to be produced.

### TECHNICAL FIELD

The invention relates to a process for producing a discharge lamp, in particular a dielectric barrier discharge lamp.

Depending on the particular type of lamp, discharge lamps may have one or more functional layers, for example a phosphor layer in the case of fluorescent lamps or additionally a reflective layer in the case of aperture lamps. Moreover, in the case of dielectric barrier discharge lamps, i.e. lamps which are operated on the basis of what are known as dielectric barrier discharges, if electrodes are arranged inside the discharge vessel (internal electrodes), a dielectric layer, e.g. a soldering glass layer, is required to isolate the internal electrodes from the discharge medium. Moreover, soldering glass layers are also used for the gastight joining of the individual parts of the vessel of flat discharge lamps, for example by a soldering glass layer in the form of a frame being applied to a first vessel plate and then being fused to the second vessel plate.

To apply these layers, in the case of flat discharge lamps by means of printing or spraying technology, for example, first of all the base material, i.e. for example a phosphor, a reflective substance or a soldering glass in powder form, is mixed with binder and solvents to form a paste. The viscosity of the paste is influenced, inter alia, by the selected type and quantity of the solvent and depends on the technique used to apply the particular layer, e.g. screen printing, spraying or dispensing. It is difficult to expel the binder from the respective layer without leaving residues, an operation known as binder removal, which has to take place prior to filling with the discharge medium and gastight closure of the discharge vessel. Binder removal without leaving residues is important because the discharge medium must remain as pure as possible in order to ensure that the lamp operates efficiently and without faults and also has a long service life. The binder removal is usually realized by heating the coated parts or the lamp vessel which has already been prefabricated and carrying away the binder constituents expelled, e.g. by means of flowing gas, evacuation or the like. In this context, the duration of heating and the level of the temperature must be selected according to the type of binder used in order to ensure binder removal without leaving any residues. However, high temperatures may also damage phosphors. Moreover, the softening point of the glasses and soldering glasses used must be significantly higher than the binder removal temperature.

### PRIOR ART

Document EP 1 239 507 A1 discloses the production of a flat fluorescent lamp based on dielectric barrier discharges, with the phosphor layer being applied by spraying. The low-viscosity phosphor suspension used for this purpose comprises 40 to 60 percent by weight of phosphor, 1 to 5 percent by weight of an organic binder, e.g. ethylcellulose or nitrocellulose, and a solvent, e.g. ethanol, terpineol or 2-(2-butoxyethoxy) ethyl acetate (BCA).

### SUMMARY OF THE INVENTION

The object of the present invention is to provide a process for producing a discharge lamp which is improved with regard to the application of functional layers.

This object is achieved by a process for producing a discharge lamp, comprising the following process steps:
a. providing a discharge vessel,
b. producing a paste for a functional layer from the following components:
   pulverulent base material,
   polyalkylene carbonate as binder,
   solvent,
c. forming the functional layer by applying the paste to at least part of the wall of the discharge vessel,
d. if necessary, repeating steps b and c if more than one functional layer is intended.

Particularly advantageous configurations are given in the dependent claims.

The pulverulent base material used depends on what type of functional layer is to be applied. To form a phosphor layer, it consists of a phosphor or phosphor mixture, to form a reflective layer it consists of a reflective substance, e.g. Al₂O₃ or TiO₂, or reflective substance mixture or a hybrid of two or more reflective layers, and to form a dielectric layer as functional layer it consists of a soldering glass, e.g. Pb—B—Si—O, or soldering glass mixture. The polyalkylene carbonate used as binder comprises the two variants polyethylene carbonate and polypropylene carbonate, which are supplied, for example, by Empower Materials under designations QPAC 25® and QPAC 40®, respectively. A value of approx. 01 to 5%, in particular 0.5 to 3%, very particularly 0.5 to 2%, has proven suitable as the proportion by weight, based on the total weight of the paste, formed by the binder polyalkylene carbonate. One of the advantages of using QPAC is that binder removal without residues can be achieved even at relatively low temperatures of approx. 250 to 300° C. This firstly allows lamps with a high degree of purity in the interior of the discharge vessel to be realized without problems in relative terms. Furthermore, this also increases the choice of suitable soldering glasses with a softening point which is above the binder removal temperature.

Examples of suitable solvents include ethyl acetate and/or propylene glycol diacetate (PGDA). The choice of solvent or mixture depends on the desired spray properties, the wetability and the run-off properties of the finished suspension, as well as the preferred evaporation rate of the solvent, in the particular case. These properties can in turn be matched to the form of precursor material that is to be coated.

### BRIEF DESCRIPTION OF THE DRAWINGS

The invention is to be explained in more detail below on the basis of an exemplary embodiment. In the drawing:

FIG. 1a shows a sectional illustration of the base plate and front plate of the discharge vessel of a flat dielectric barrier discharge lamp,

FIG. 1b shows an enlarged view of a detail of the base plate,

FIG. 1c shows an enlarged view of a detail of the front plate,

FIG. 2 shows the same as FIG. 1a, but in the joined state.

### PREFERRED EMBODIMENT OF THE INVENTION

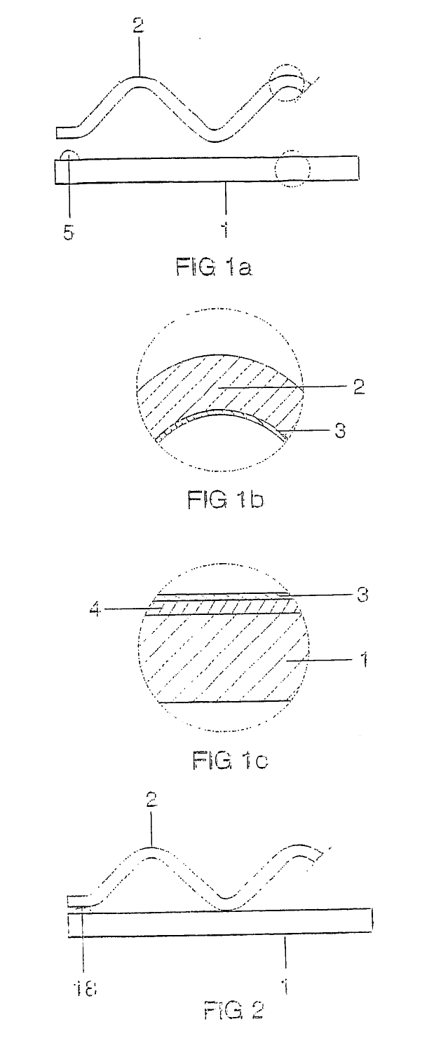

The exemplary embodiment which is diagrammatically depicted in FIG. 1a to 2 relates to the production of a flat dielectric barrier discharge lamp, the discharge vessel of which substantially comprises a planar base plate 1 and a ribbed front plate 2. In this respect, reference is made to documents US 2002/0163311 A1 and WO 03/017312, where a lamp of this type and its production have already been disclosed. FIG. 1 shows the flat base plate 1, on which the corrugated front plate 2 is to come to bear, and then the two plates are to be joined to one another in a gastight manner to form the discharge vessel. First of all, however, the inner side of the front plate 2, which has a “ribbed structure” as disclosed in the abovementioned US 2002/0163311, is provided with a triband phosphor layer 3 (not visible in FIG. 1a; cf. in this respect the enlarged view presented in FIG. 1b). For this purpose, the three pulverulent phosphor components barium magnesium aluminate (BaMgAl₁₀ O₁₇:Eu), lanthanum phosphate (LaPO₄:(Tb, Ce)) and gadolinium yttrium borate ((Gd, Y)BO₃:Eu), forming 30 percent by weight, are mixed with 1.3 percent by weight of QPAC 40, 55.7 percent by weight of PGDA and 13 percent by weight of ethyl acetate, and this mixture is then sprayed onto the front plate 2. On account of the specific composition of the abovementioned phosphor suspension, the required properties with regard to spraying properties, wetability and run-off properties are achieved; these properties represent a required condition for uniform spray coating of the abovementioned ribbed structure of the front plate 2. First of all, a reflective layer 4 is applied to the inner side of the planar base plate 1, and then a triband phosphor layer 3, corresponding to that on the front plate 2, is applied to the reflective layer 4 (not visible in FIG. 1a; cf. in this respect the enlarged view presented in FIG. 1c). The layer weights of the phosphor layer and the reflective layer are approx. 3 mg/cm² and 10 mg/cm², respectively. A mixture comprising 35 percent by weight of Al₂O3, 1.5 percent by weight of QPAC 40 and 63.5 percent by weight of PGDA is produced for the reflective layer 4 and applied. Moreover, a soldering-glass bead 5 is applied to the base plate 1 in the form of a frame running all the way around the outer edge of the base plate 1 (cf. FIG. 1a). A mixture made up of 81 percent by weight of pulverulent Pb—B—Si—O soldering glass, 1 percent by weight of QPAC 40 and 18 percent by weight of PGDA was used for this purpose. After drying, the binder was removed from layers 3 to 5 at a temperature of 280° C. for one hour in a furnace with air flowing through it (not shown). Then, the base plate 1 and the front plate 2 were joined together in a gastight manner in a discharge medium atmosphere, in this case pure xenon, for which purpose the frame-like soldering glass layer 5 is softened by heating. After the joining of the discharge vessel, the electrode tracks are also applied to the outer side of the base plate 1 (not shown). For further details of this operation, reference is likewise made to WO 03/017312 cited above.

For the case of dielectric barrier discharge lamps with internal electrodes, the dielectric layer which is then required to separate the electrodes from the discharge medium can be realized by applying a corresponding soldering glass layer, in the same way as described above.

Although the invention has been explained in more detail above on the basis of the example of the production of a flat dielectric barrier discharge lamp, the advantageous effect of the invention and the claimed protection also extends to the production in accordance with the invention of discharge lamps with other shapes of discharge vessels, in particular also to tubular discharge lamps, and also discharge lamps with conventional electrodes rather than dielectric barrier electrodes.

1. A process for producing a discharge lamp, comprising the following process steps:
a. providing a discharge vessel,
b. producing a paste for a functional layer from the following components:
pulverulent base material,
polyalkylene carbonate as binder,
solvent,
c. forming the functional layer by applying the paste to at least part of the wall of the discharge vessel,
d. if necessary, repeating steps b and c if more than one functional layer is intended.

2. The process as claimed in claim 1, in which the pulverulent base material comprises a phosphor or phosphor mixture in order to form a phosphor layer (3) as functional layer.

3. The process as claimed in claim 2, in which the phosphor or the phosphor mixture comprises one or more components selected from the group consisting of BaMgAl₁₀O₁₇:Eu, LaPO₄:(TB, Ce), (Gd, Y)BO₃:Eu.

4. The process as claimed in claim 1, in which the pulverulent base material consists of a reflective substance or reflective substance mixture, in order to form a reflective layer (4) as functional layer.

5. The process as claimed in claim 4, in which the reflective substance or the reflective substance mixture comprises A1₂O₃ and/or TiO₂.

6. The process as claimed in claim 1, in which the pulverulent base material consists of a soldering glass or soldering glass mixture, in order to form a soldering glass layer (5) as functional layer.

7. The process as claimed in claim 6, in which the soldering glass or soldering glass mixture comprises Pb—B—Si—O.

8. The process as claimed in claim 1, in which the solvent comprises ethyl acetate.

9. The process as claimed in claim 1, in which the solvent comprises propylene glycol diacetate.

10. The process as claimed in claim 1, in which the binder polyalkylene carbonate forms approx. 0.5 to 2% by weight, in particular 1 to 1.5% by weight.

11. The process as claimed in claim 1, in which the polyallkylene carbonate used as binder is polypropylene carbonate.

12. The process as claimed in claim 1, in which the paste is applied by spraying, dispensing or screen printing.

13. The process as claimed in claim 1, in which the discharge lamp is designed as a flat discharge lamp and the discharge vessel comprises two substantially planar plates (1, 2) which are joined to one another in a gastight manner.

14. The process as claimed in claim 1, in which the discharge lamp is designed for operation based on dielectric barrier discharges.

15. The process as claimed in claim 2, in which the pulverulent base material consists of a reflective substance or reflective substance mixture, in order to form a reflective layer (4) as functional layer.

16. The process as claimed in claim 3, in which the pulverulent base material consists of a reflective substance or reflective substance mixture, in order to form a reflective layer (4) as functional layer.
